(19) United States
(12) Patent Application Publication
(10) Pub. No.: US 2010/0053834 A1
(43) Pub. Date: Mar. 4, 2010

(54) THERMAL PROTECTION CIRCUIT FOR POWER SUPPLY

(76) Inventor: CHIH-CHIEN CHIEN, Taoyuan County (TW)

Correspondence Address: Chien-Hui Su, P. O. Box 70-121 Taichung, Taichung City, 40899, TW

(21) Appl. No.: 12/202,420

(22) Filed: Sep. 1, 2008

(51) Int. Cl. H02H 5/04

(52) U.S. Cl. 361/103

(57) ABSTRACT

A thermal protection circuit includes a driving circuit having a thermal control chip electrically disposed thereon. The driving circuit has a first output terminal for outputting voltage and a second output terminal for outputting thermal control voltage. A compare circuit is electrically connected to the driving circuit. The compare circuit includes a comparator electrically disposed thereon for forming a control voltage thereon. The second output terminal of the thermal control chip is electrically connected to the comparator. The comparator forms a base voltage that is determined on the control voltage and the output voltage. A detection circuit is electrically connected to the compare circuit and includes an input terminal disposed thereon for receiving the control voltage. The detection circuit detects the control voltage for controlling to close/open the thermal protection circuit.

### BACKGROUND OF THE INVENTION

1. Field of the Invention

The present invention relates to a protection circuit, and more particularly to a thermal protection circuit for a power supply.

2. Description of Related Art

As well known, a thermal protection circuit is usually used to automatically transmit an on/off signal to electric equipments for turn on/off the electric equipments and protecting the electric equipments from damages due to a high temperature. The conventional thermal protection circuits are divided into two types including physical controlled type and electric controlled type.

With reference to FIG. 4 that show a conventional physical controlled type thermal protection circuit (911) that is electrically connected to a power supply (901), the electric current of the power supply does not influence control effect such that the conventional thermal protection circuit (911) can be freely connected to a primary-side or a secondary-side of another power supply (912), as shown in FIG. 5, for automatically cutting off/electrifying the power supply. Furthermore, the conventional physical controlled type thermal protection circuit (911) still can be normally operated when the power supply (911/912) is cut off.

However, the physical properties of the physical controlled protection circuit (911), relative to the temperature variation, are used as an operational trigger for the power supply such that the sensitivity of the physical controlled protection circuit (911) due to the temperature variation is feeble and it is difficultly to adjust the operational temperature in a best mode.

With reference to FIG. 6, an electric controlled type thermal protection circuit (913) is electrically connected to a secondary-side of the power supply (901). The operational temperature of the protection circuit (913) can be freely and easily adjusted for overcoming the disadvantages of the physical controlled type thermal protection circuit (911), hereinbefore.

However, the electric controlled type thermal protection circuit (913) can not be operated relative to the electric current such that the protection circuit (913) can not be electrically connected to the primary-side that has a smaller electric current than that of the secondary-side of the power supply.

The present invention has arisen to mitigate and/or obviate the disadvantages of the conventional thermal protection circuits.

### SUMMARY OF THE INVENTION

The main objective of the present invention is to provide an improved thermal protection circuit that is electrically connected to a primary-side of a power supply for saving energy and accurately controlling the power supply.

To achieve the objective, the thermal protection circuit in accordance with the present invention comprises a driving circuit having a thermal control chip electrically disposed thereon. The driving circuit has a first output terminal for outputting voltage and a second output terminal for outputting thermal control voltage. A compare circuit is electrically connected to the driving circuit. The compare circuit includes a comparator electrically disposed thereon. The comparator includes a third output terminal, a first input terminal and a second input terminal respectively disposed thereon. The comparator forms a control voltage on the third output terminal. The second output terminal of the thermal control chip is electrically connected to the second input terminal of the comparator and the first input terminal of the comparator forms a base voltage that is determined on the control voltage and the output voltage. The comparator compares the thermal control voltage on the second input terminal with the base voltage on the first input terminal for controlling the control voltage on the third output terminal. A detection circuit is electrically connected to the compare circuit and includes a third input terminal disposed thereon for receiving the control voltage. The detection circuit detects the control voltage for controlling to close/open the thermal protection circuit.

Further benefits and advantages of the present invention will become apparent after a careful reading of the detailed description with appropriate reference to the accompanying drawings.

### BRIEF DESCRIPTION OF THE DRAWINGS

FIG. 1 is a circuit diagram of a thermal protection circuit in accordance with the present invention;

FIG. 2A is an equivalent circuit diagram of the output voltage, the base voltage and the control voltage when the comparator is in a LOW condition;

FIG. 2B is an equivalent circuit diagram of the output voltage, the base voltage and the control voltage when the comparator is in a HIGH condition;

FIG. 3 is a block diagram for showing thermal protection circuit electrically connected to a primary-side of a power supply;

FIG. 4 is a block diagram for showing a conventional physical controlled type thermal protection circuit electrically connected to a primary-side of a power supply;

FIG. 5 is a block diagram for showing a conventional physical controlled type thermal protection circuit electrically connected to a secondary-side of a power supply; and

FIG. 6 is a block diagram for showing a conventional electric controlled type thermal protection circuit electrically connected to a secondary-side of a power supply.

### DETAILED DESCRIPTION OF THE INVENTION

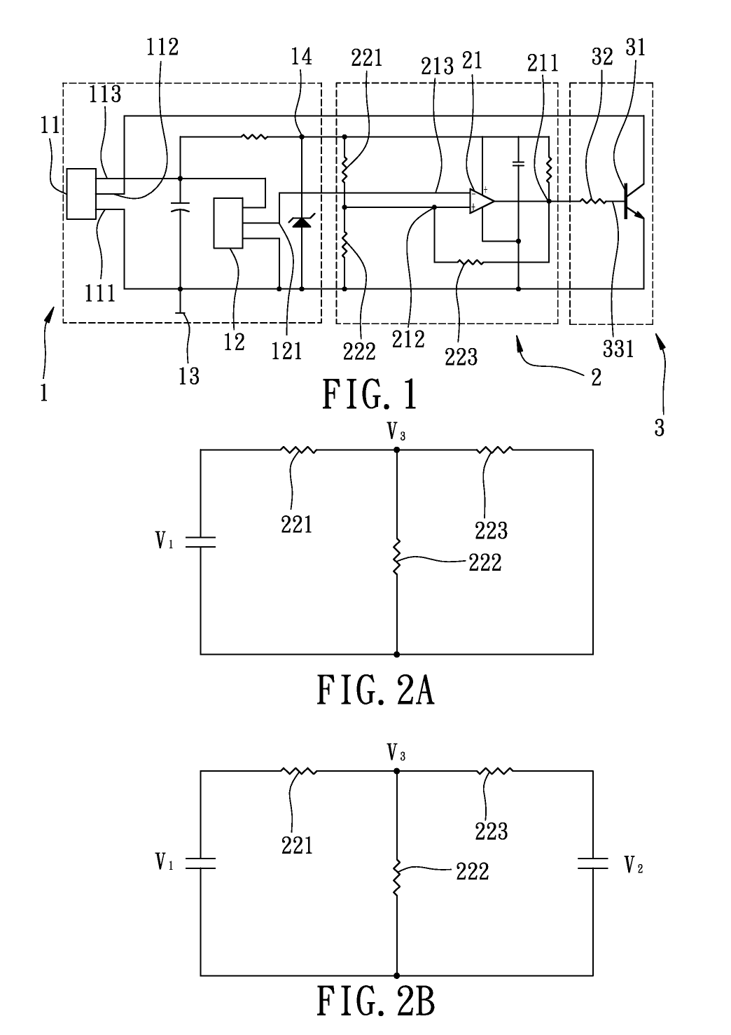

Referring to the drawings and initially to FIGS. 1-2, a thermal protection circuit for a power supply in accordance with the present invention comprises a driving circuit (1), a compare circuit (2) and a detection circuit (3) sequentially and electrically connected to one another.

The driving circuit (1) includes a connector (11) and a thermal control chip (12) electrically connected thereon, wherein the connector (11) is adapted to be connected to an extra power source. The connector (11) has a first terminal (111) electrically connected to a ground terminal (13) of the driving circuit (1), a second terminal (112) electrically connected to the detection circuit (3), and a third terminal (113) electrically connected to the thermal control chip (12) and a first output terminal (14) disposed on the driving circuit (1). The thermal control chip (12) is provided to receive the power from the connector (11) and has a second output terminal (121) disposed thereon. The thermal control chip (12) transmits different thermal control voltage to the second output terminal (121) due to the temperature variation. In the preferred embodiment of the present invention, a direct ratio is formed between the temperature and the thermal control voltage in the thermal control chip (12).

The compare circuit (2) includes a comparator (21) disposed thereon. The comparator (21) has a third output terminal (211), a first input terminal (212) and a second input terminal (213) respectively disposed thereon. The comparator (21) compares the voltage of the first input terminal (212) with that of the second input terminal (213) and outputs a control voltage via the third output terminal (211). The second input terminal (213) is electrically connected to the second output terminal (121) of the thermal control chip (12) for receiving the control voltage from the thermal control chip (12).

The first input terminal (212) of the comparator (21) is respectively electrically connected to the first output terminal (14) and the ground terminal (13) of the driving circuit (1), wherein a first resistance (221) is disposed between the first input terminal (212), and a second resistance (222) is disposed between the first input terminal (212) and the ground terminal (13). The third output terminal (211) is electrically connected to the first input terminal (212), and a third resistance (223) is disposed between the third output terminal (211) and the first input terminal (212) for forming a feedback loop. As a result, the first input terminal (212) of the comparator (21) forms a base voltage that is determined on the control voltage and the output voltage. The comparator (21) compares the thermal control voltage from the second input terminal (213) with the base voltage from the first input terminal (212) for controlling the control voltage of the third output terminal (211).

The comparator (21) is in a LOW condition and the control voltage of the third output terminal is zero when the thermal control voltage from the second input terminal (213) is greater than the base voltage from the first input terminal (212). At the same time, the base voltage is equal to the divided voltage of the first resistance (221) after the output voltage being sequentially series connected to the first resistance (221), and the parallel connected second resistance (222) and the third resistance (223). With reference to FIG. 2A that is an equivalent circuit diagram of the output voltage (V₁), the base voltage (V₃), the control voltage (V₂), the first resistance (221), the second resistance (222) and the third resistance (223) when the comparator (21) is in the LOW condition, the control voltage (V₂) is zero and ignored, hereinbefore. The comparator (21) is in a HIGH condition and the control voltage from of the third output terminal (221) is not equal to zero when the base voltage of the first input terminal (212) is greater than the thermal control voltage of the second input terminal (213). At the same time, the base voltage is the continued value respectively relative to the output voltage, the ground terminal (13) and the control voltage after being parallel connected with the first resistance (221), the second resistance (222) and the third resistance (223), as shown in FIG. 2B that is an equivalent circuit diagram of the output voltage (V₁), the base voltage (V₃), the control voltage (V₂), the first resistance (221), the second resistance (222) and the third resistance (223) when the comparator (21) is in the HIGH condition.

The detection circuit (3) includes a transistor (31) electrically disposed thereon. The transistor (31) has a base used as a third input terminal (311) and electrically connected to the third output terminal (211) via a fourth resistance (32). The transistor (31) has a collector electrically connected to the second terminal (112) of the connector (11) of the driving circuit (1) and an emitter electrically connected to the ground terminal (13) to form a loop. The base of the transistor (31) is provided to detect the control voltage for controlling transistor (31) to close/open. The transistor (31) is in a cut-off mode and the electric current between the collector and the emitter is zero when the comparator (21) is in the LOW condition and the control voltage, from the third output terminal (211) of the comparator (21) to the base of the transistor (31), is zero. On the contrary, the control voltage, form the third output terminal (211) of the comparator (21) to the base of the transistor (31), makes the transistor (31) is a saturation mode, and the collector and the emitter is electrically connected to control the transistor (31) when the comparator (21) is in the HIGH condition.

The operation of the protection circuit is concerned to the Schmit-trigger theory because the base voltage is determined by the output voltage and the control voltage. With reference to FIGS. 2A and 2B, the base voltage is greater when the comparator (21) is the HIGH condition than the comparator (21) is in the LOW condition due to the control voltage. The comparator (21) compares the thermal control voltage with the base voltage to determine on HIGH/LOW condition. The comparator (21) is originally situated in HIGH condition and the transistor (31) is in the saturation mode such that the thermal protection circuit needs a high background temperature used as a close temperature. The comparator (21) is turned to the LOW condition to make the transistor (31) in an open mode for cutting off the power when the base voltage is lower than the thermal control voltage that is occurred by the thermal control chip (12) according to the background temperature. On the contrary, the comparator (21) is originally situated in LOW condition and the transistor (31) is in the close mode such that the thermal protection circuit needs a low background temperature used as a reset temperature. The comparator (21) is turned to the HIGH condition to make the transistor (31) in a close mode for resetting the power when the base voltage is higher than the thermal control voltage that is occurred by the thermal control chip (12) according to the background temperature. The transistor (31) is in the saturation mode again.

In the thermal protection circuit of the present invention, the thermal control ship (12) is used to control the variation ratio of the thermal control voltage and the temperature. The thermal control chip (12) effectively controls the sensation and accuracy of the thermal protection circuit relative to the background temperature, and sets the close temperature and the reset temperature.

Furthermore, the thermal protection circuit in accordance with the present invention can be electrically connected to the primary-side such that the thermal protection circuit needs a small electric current when being operated.

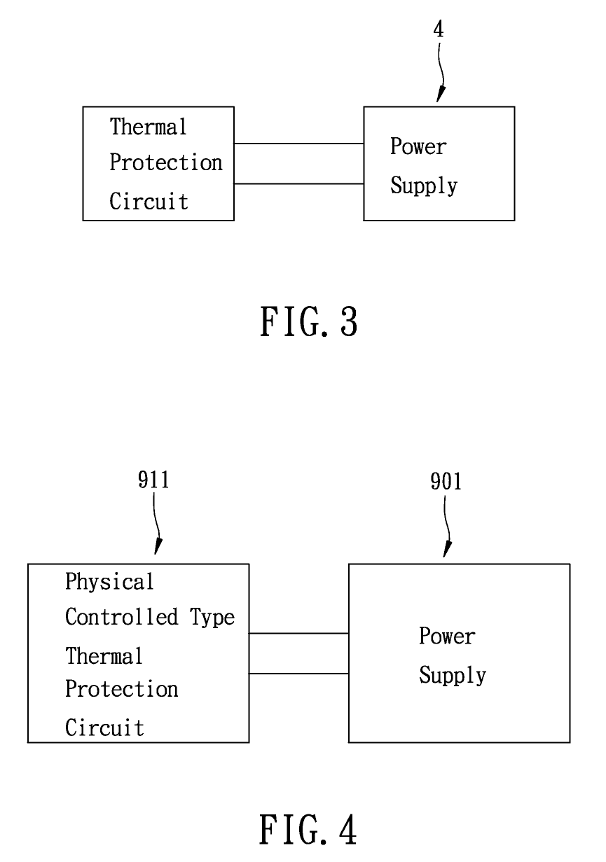

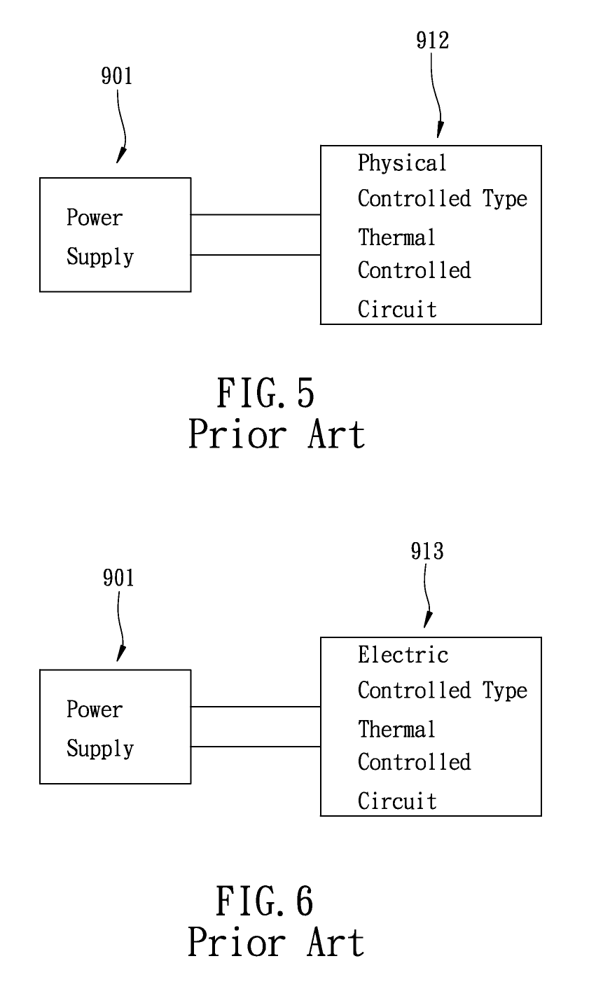

With reference to FIG. 3, the thermal protection circuit of the present invention is electrically connected to a primary-side of a power supply for controlling and protecting the power supply from being damaged due to a high temperature.

Although the invention has been explained in relation to its preferred embodiment, it is to be understood that many other possible modifications and variations can be made without departing from the spirit and scope of the invention as hereinafter claimed.

What is claimed is:

1. A thermal protection circuit for power supply, comprising:
a driving circuit having a thermal control chip electrically disposed thereon, the driving circuit having a first output terminal for outputting voltage and a second output terminal for outputting thermal control voltage;
a compare circuit electrically connected to the driving circuit, the compare circuit including a comparator electrically disposed thereon, the comparator including a third output terminal, a first input terminal and a second input terminal respectively disposed thereon, the comparator forming a control voltage on the third output terminal, the second output terminal of the thermal control chip electrically connected to the second input terminal of the comparator, the first input terminal of the comparator forming a base voltage that is determined on the control voltage and the output voltage, the comparator comparing the thermal control voltage on the second input terminal with the base voltage on the first input terminal for controlling the control voltage on the third output terminal; and
a detection circuit electrically connected to the compare circuit, the detection circuit including a third input terminal disposed thereon for receiving the control voltage, the detection circuit detecting the control voltage for controlling to close/open the thermal protection circuit.

2. The thermal protection circuit as claimed in claim 1, wherein the first input terminal of the comparator is electrically connected to the first output terminal and a ground terminal via a first resistance and a second resistance, and the third output terminal of the comparator is electrically connected to the first input terminal via a third resistance.

3. The thermal protection circuit as claimed in claim 1, wherein the detection circuit includes a transistor electrically disposed thereon, the transistor having a base used as a third input terminal of the detection circuit, the third input terminal electrically connected to the third output terminal via a fourth resistance.

4. The thermal protection circuit as claimed in claim 2, wherein the detection circuit includes a transistor electrically disposed thereon, the transistor having a base used as a third input terminal of the detection circuit, the third input terminal electrically connected to the third output terminal via a fourth resistance.
